(19) United States
(12) Patent Application Publication
(10) Pub. No.: US 2012/0015768 A1
(43) Pub. Date: Jan. 19, 2012

(54) Isolating Pulley

(76) Inventors: Alexander Serkh, Troy, MI (US); Peter Ward, Farmington Hills, MI (US); Imtiaz Ali, Lathrup Village, MI (US); Dean Schneider, Washington, MI (US)

(21) Appl. No.: 12/804,045

(22) Filed: Jul. 13, 2010

(51) Int. Cl. F16H 55/36

(52) U.S. Cl. 474/94

(57) ABSTRACT

An isolator comprising a hub, a pulley journalled to the hub, the pulley having a stop, the hub having a resilient member for engaging the stop, a torsion spring connected between the pulley and the hub, an inertial member attached to the hub by a flexible member, the inertial member disposed within a pulley receiving portion that is disposed radially inward of a pulley belt engaging surface, and the resilient member having a convex surface for engaging the stop such that a spring rate of the resilient member is non-linear upon a compression against the stop.

### FIELD OF THE INVENTION

The invention relates to an isolating pulley, and more particularly, to an isolating pulley comprising an isolator having a resilient member having a convex surface for engaging the stop such that a spring rate of the resilient member is non-linear upon a compression by the stop.

### BACKGROUND OF THE INVENTION

Vehicle internal combustion engines typically comprise a front end belt driven accessory drive. The accessories can include power steering, an alternator, water pump and so on. The accessory drive can also be referred to as a serpentine drive since the belt often traces a circuitous path about the front plane of an engine.

A typical serpentine drive system includes a driving pulley on the crankshaft of an internal combustion engine of the vehicle, a series of driven pulleys for the accessories and a poly-V belt trained about the driving and driven pulleys. An advantage of the serpentine drive is that by providing an automatic belt tensioner on the belt the accessories can be fixedly mounted.

It is also known to provide a decoupler assembly between the belt driven accessory and the pulley to allow the belt driven accessory to operate temporarily at a higher speed or “overrun” the pulley as the pulley oscillates with the speed of the engine.

It is known that alternator pulley can contain one-way clutch, resilient member, or both one-way clutch and resilient member. It is also known that the same approach can be used for crankshaft pulley. In the latter case not only the alternator inertia will be isolated from the belt drive but the inertia of all accessories. At the same time torque requirement is substantially higher as well as challenges for all other elements of the crankshaft isolator.

For a crankshaft isolator with no decoupling feature, the spring stiffness is chosen such that the torsional vibration present at the nose of the crankshaft is attenuated by its elastic element and prevented this vibration from affecting the ABDS in a negative manner. Although beneficial during engine operation, the presence of the device on the crankshaft during start-up and shut down can present challenges. Because the spring stiffness is such that the first system natural frequency is below idle, during start up, the engine RPM passes through this natural frequency causing exaggerated relative motion between the device's pulley and hub. This causes large deformations of the elastic element and can result in fatigue fractures and catastropic failure. This failure can be prevented by the use of stop(s) between the pulley and the hub that limit the travel of the elastic element. However, the stops must be placed and designed correctly to prevent objectionable noise during the start up phase of engine operation.

Representative of the art is U.S. Pat. No. 7,591,357 B2 which discloses a decoupler (22) is provided for transferring rotary movement between an engine driven crankshaft (16) and a serpentine belt (20). The decoupler (22) has a rotary driving member (18, 36) and a rotary driven member (36, 18) coaxially mounted with the driving member for relative rotary movement therewith. A decoupling assembly (19) extends between the driving member (18, 36) and the driven member (36, 18). The decoupling assembly (19) selectively couples the driving and driven members (18, 36) when the driving member rotates relative to the driven member in a first coupling sense. The decoupling assembly (19) uncouples the driving member from the driven member when the driving member rotates relative to the driven member in a second sense opposite the first sense. A torsional vibration damper (80) is mounted for rotation with one of the driving and driven members (18, 36) to cancel some of the vibrations generated by the engine.

What is needed is an isolator having a resilient member having a convex surface for engaging the stop such that a spring rate of the resilient member is non-linear upon a compression by the stop. The present invention meets this need.

### SUMMARY OF THE INVENTION

The primary aspect of the invention is an isolator having a resilient member having a convex surface for engaging the stop such that a spring rate of the resilient member is non-linear upon a compression by the stop.

Other aspects of the invention will be pointed out or made obvious by the following description of the invention and the accompanying drawings.

The invention comprises an isolator comprising a hub, a pulley journalled to the hub, the pulley having a stop, the hub having a resilient member for engaging the stop, a torsion spring connected between the pulley and the hub, an inertial member attached to the hub by a flexible member, the inertial member disposed within a pulley receiving portion that is disposed radially inward of a pulley belt engaging surface, and the resilient member having a convex surface for engaging the stop such that a spring rate of the resilient member is non-linear upon a compression against the stop.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a cross sectional view of the device.

FIG. 2 is a perspective view of the device.

FIG. 3 is an exploded view of the device.

FIG. 4 is a partial exploded view.

FIG. 5 is a detail of a resilient member.

FIG. 6 is a graph showing spring torque changes as engine idle.

FIG. 7 is a graph showing stop stiffness.

FIG. 8 is a graph showing stop compression.

FIG. 9 is a graph showing displacement versus torque.

### DETAILED DESCRIPTION OF THE PREFERRED EMBODIMENT

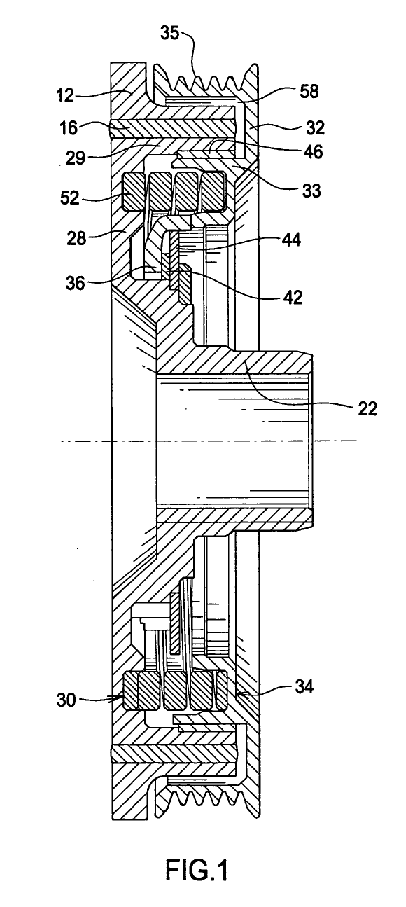

FIG. 1 is a cross sectional view of the device. The isolator comprises a pulley 32. Pulley 32 is journalled to the hub 28 through a bushing 46. Bushing 46 is disposed between pulley cylindrical portion 33 and hub cylindrical portion 29. Bushing 46 has a coefficient of friction in the range of 0.06 to 0.15.

A belt (not shown) engages a belt engaging surface 35.

A torsion spring 52 is connected between hub 28 and pulley 32. Torsion spring 52 has a stiffness of approximately 3 Nm/deg.

Each end of the torsion spring 52 is pressed into a circumferential pocket 34 in hub 28 and into circumferential pocket 30 in pulley 32. Torsion spring 52 can transmit torque in both directions (winding and unwinding).

The inventive isolator also includes a crankshaft damper which consists of damper inertia member 12 and a rubber element 16. Rubber element 16 is disposed between the inertia member 12. Inertia member 12 is disposed within a receiving portion 58, thereby reducing the overall length of the isolator. Receiving portion 58 is disposed radially inward of the pulley belt engaging surface 35.

Hub 28 has a portion of it 22 to interface with engine crankshaft. Pulley 32 has stops 36 with frictional elements 42 for thrust load. Retainer 44 is attached to hub 28 with screws 74. Travel of pulley 32 is limited by soft stops 38 installed in the hub 28.

A retainer 44 is used to hold resilient members 38 in place on the hub 28. A fastener 74 is used to fasten the retainer member 42.

Pulley 32 further comprises a stop 36. Each end of the travel range of the pulley relative to the hub is limited by a stop 36. Stop 36 extends form the pulley 32 and engages a resilient member 38 at the travel limit.

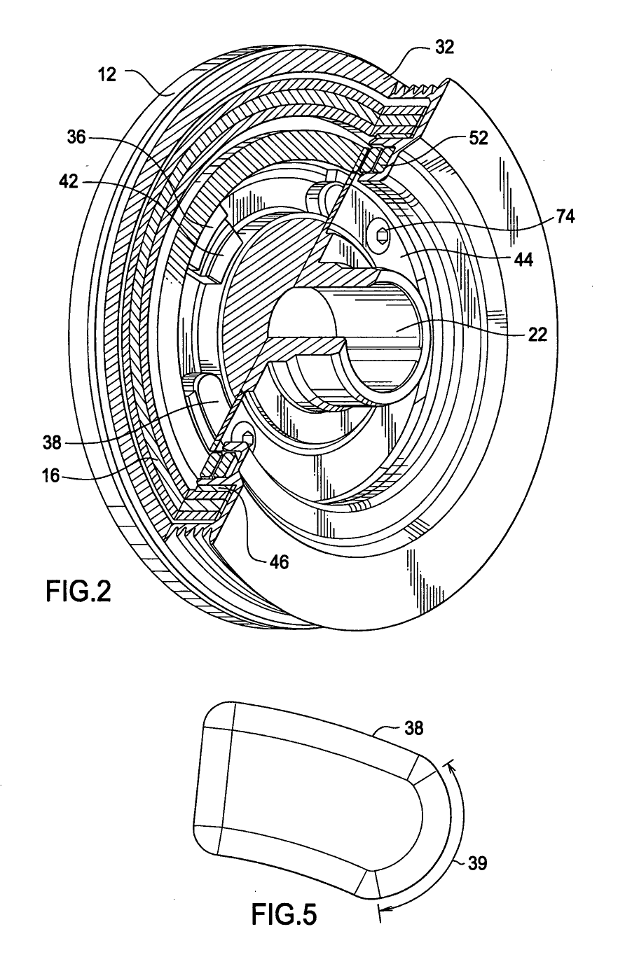

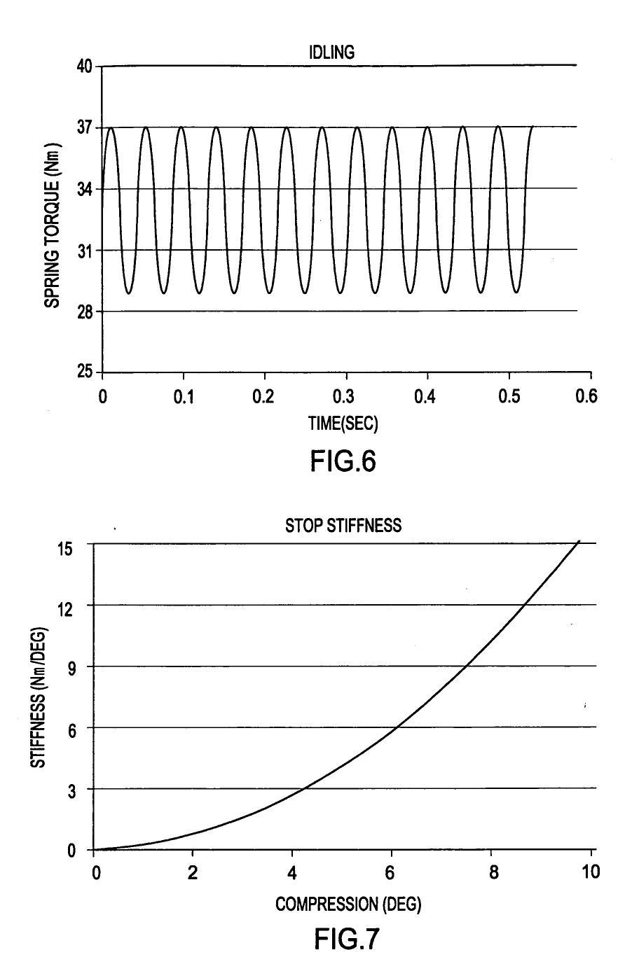

FIG. 2 is a perspective view of the device. The range of relative movement of the stop 36 between two resilient members 38 is approximately 170°. The range of movement combined with the ability to select a desired spring rate allows the isolator to be used in a wide variety of operating conditions. FIG. 6 is a graph of the spring torque as a function of engine idle. This shows the oscillator behavior of the hub 28 compared to the pulley 32. In other words there is some relative movement between the two as the engine operates.

FIG. 3 is an exploded view of the device. Each resilient member 38 is attached to hub 22 by retainer 44.

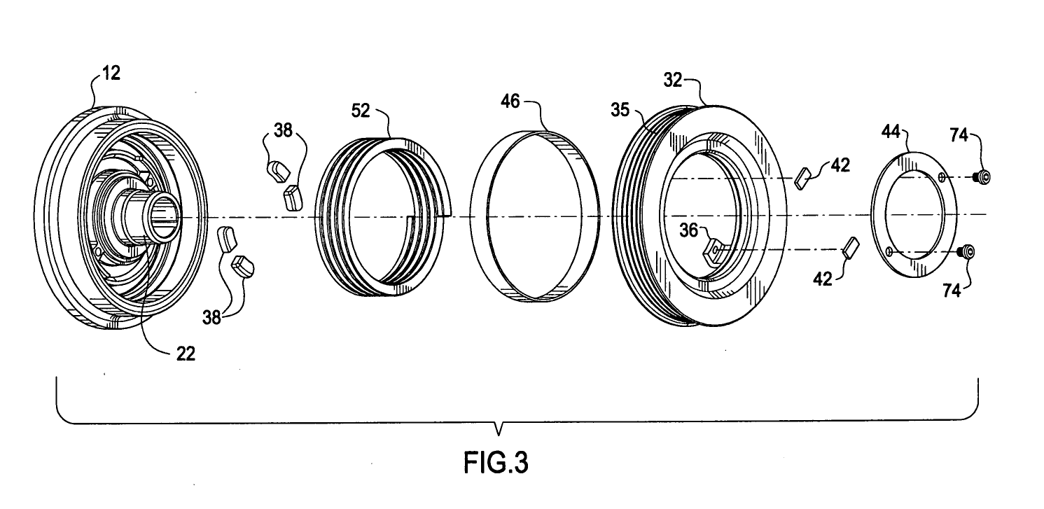

FIG. 4 is a partial exploded view. Each resilient member 38 is retained in a receiving portion 220. The resilient member 38 is constrained in the receiving portion 220 and by retainer 44. Hence, the spring rate of the resilient member increases as a compressive force is increased. Put another way, the spring rate is non-linear. FIG. 7 is a graph depicting the resilient member spring rate as a function of compression.

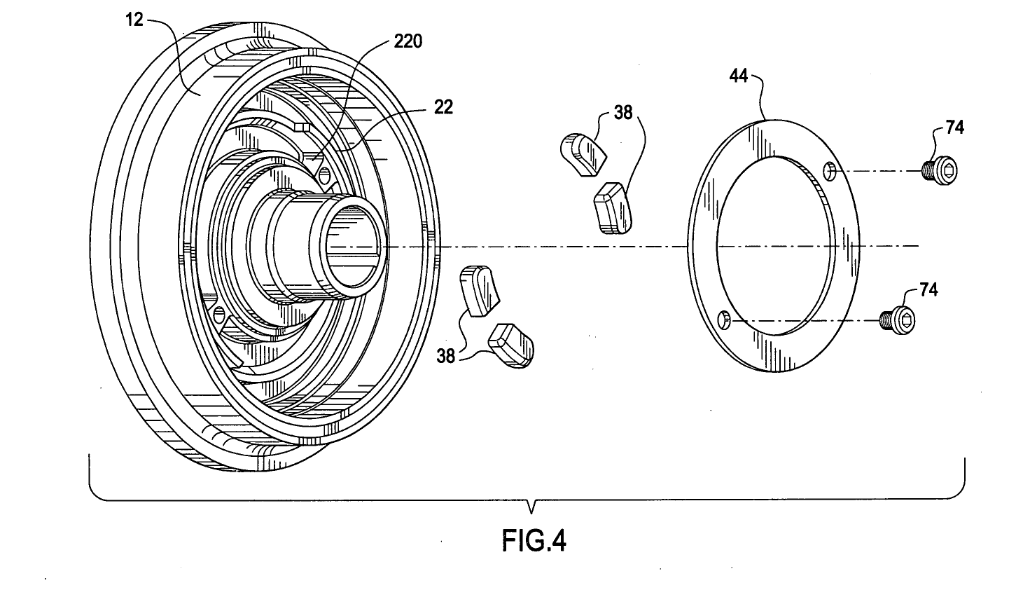

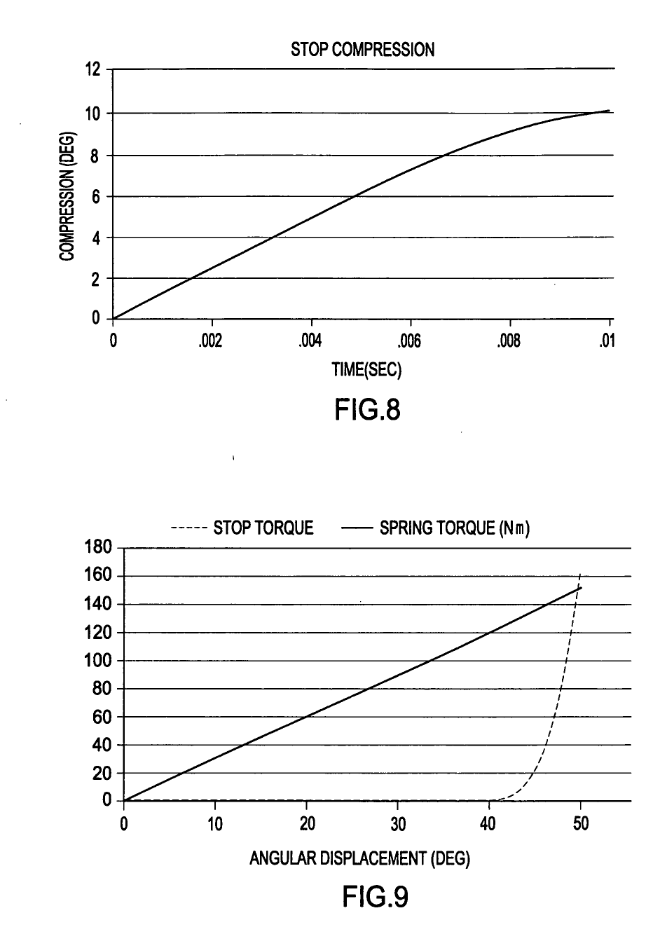

FIG. 5 is a detail of a resilient member. Each resilient member 38 comprises an arcuate portion 39. The convex form of the arcuate portion provides a progressive spring rate so that as the stop 36 engages the member 38, the stop and therefore the pulley is gradually decelerated. This minimizes any noise that might otherwise be generated by an abrupt contact between the stop and the member 38. The convex surface 39 creates an increasing spring rate under compression. FIG. 8 is a graph of resilient member compression as a function of time. This typically represents the compression of the member 38 in degrees of relative rotation of the pulley compared to the hub. The duration of the impact is shown as up to 0.01 seconds to a compression of 10 degrees. Of course this characteristic can be adjusted by using a less compliant or more compliant material for member 38, which would tend to either increase or decrease the slope (Δx/Δy) of the curve.

Resilient member 38 may comprise EPDM, urethane, NR, SBR, NBR, HNBR, IIR, BIIR, CIIR, AEM, EVM, and PU, or any combination of two or more of the foregoing.

FIG. 9 is a graph showing displacement versus torque. The spring torque and stop torque are shown. One can see that the stop torque increases at an increasing rate as the stop is compressed. On the other hand, the spring torque is relatively linear over the range of angular displacement.

Although a form of the invention has been described herein, it will be obvious to those skilled in the art that variations may be made in the construction and relation of parts without departing from the spirit and scope of the invention described herein.

We claim:

1. An isolator comprising:
a hub;
a pulley journalled to the hub, the pulley having a stop;
the hub having a resilient member for engaging the stop;
a torsion spring connected between the pulley and the hub;
an inertial member attached to the hub by a flexible member, the inertial member disposed within a pulley receiving portion that is disposed radially inward of a pulley belt engaging surface; and
the resilient member having a convex surface for engaging the stop such that a spring rate of the resilient member is non-linear upon a compression against the stop.

2. The isolator as in claim 1, wherein the pulley is journalled to the hub on a bushing.

3. The isolator as in claim 1, wherein the hub comprises a receiving portion for retaining the resilient member.
